(19) United States
(12) Patent Application Publication
(10) Pub. No.: US 2006/0093157 A1
(43) Pub. Date: May 4, 2006

(54) Audio high-speed reproducing device and audio high-speed reproducing method

(75) Inventor: Hideki Seto, Nara-shi (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/261,585

(22) Filed: Oct. 31, 2005

(30) Foreign Application Priority Data
Oct. 29, 2004 (JP) 2004-315033

(51) Int. Cl. H04B 15/00

(52) U.S. Cl. 381/93

(57) ABSTRACT

An audio high-speed reproducing device which can reproduce audio data at high speed comprises: setting means for dividing each frame which constitutes the audio data and setting an object portion to be processed for each of a divided first-half block and a second-half block according to a reproduction speed of the audio data; and high-speed reproduction frame generating means for generating a high-speed reproduction frame in such a manner that the object portion to be processed of the first-half block is attenuated so that its attenuation rate becomes gradually high and the object portion to be processed of the second-half block is attenuated so that its attenuation rate gradually becomes low, and the attenuated object portion of the first-half block is superimposed onto the attenuated object portion of the second-half block.

### CROSS REFERENCE TO RELATED APPLICATION

This Nonprovisional application claims priority under 35 U.S.C. §119(a) on Patent Application No. 2004-315033 filed in Japan on Oct. 29, 2004, the entire contents of which are hereby incorporated by reference.

### BACKGROUND OF THE INVENTION

1. Field of the Invention

The present invention relates to an audio reproducing device and a video reproducing device, in particular, an audio high-speed reproducing technique which can reproduce audio data at high speed.

2. Description of the Related Art

In order to reproduce audio data or moving image data including audio data and video data, a conventional audio reproducing device or a video reproducing device comprises reading means for reading data from a storage medium such as a DVD (Digital Versatile Disk) or a CD, or means for recording data from a communication network in a storage medium such as a hard disk or a flash memory and for reading the data recorded in the storage medium, for example. Furthermore, it comprises means for separating the acquired data to audio data and video data and the separated audio data and video data are stored in a buffer memory such as a SDRAM (Synchronous DRAM).

When the audio data or the moving image data is compressed, the audio data or the moving image data is decoded by decoding means for decoding the compressed audio data or moving image data. The decoding means includes audio decoding means corresponding to ISO (International Organization for Standardization) such as MP3 (Moving Picture Experts Group phase 3), AAC (Advanced Audio Coding), G721 or G726, and video decoding means corresponding to ISO of media integrated video compression such as H.264, MPEG2, MPEG4 and the like. Thus, the decoded audio data is reproduced by an audio decoder and the decoded video data is displayed by a video decoder.

The above audio reproducing device and the video/audio reproducing device has a function to switch a reproduction speed at the time of reproduction in general. Thus, a user can retrieve desired audio or video by a fast-forward, a fast-rewind function and the like. In addition, there is a device having a function to reproduce voice at high speed, in addition to the function to reproduce video at high speed in a fast-forward operation.

As a technique to reproduce sound at high speed along a time axis of a reproduction speed without cutting the voice nor generating noise at the time of high-speed reproduction, there is an audio reproducing device which minimizes omission of audio data by superimposing audio signals of a plurality of frames. According to this audio reproducing device, at the time of high-speed searching and the like in a video system especially, a time lag between display of the video and reproduction of the audio can be reduced and superimposed sound can be easy to hear by performing weighted addition of the voice at the time of superimposing.

Furthermore, an audio reproducing device in which audible sound is divided into frames by the predetermined time and a part of each frame is superimposed onto an adjacent frame to shorten a reproduction time is disclosed (refer to JP-A 07-98933, for example). According to this audio reproducing device, when the video is searched at high speed, a time lag between the display of the video and the output of the voice can be reduced. In addition, the omission of the audio signal can be minimized. Furthermore, since the voice having a small time difference with the video is mainly reproduced by performing the weighted addition of the audio signals at the time of superimposing, the superimposed sound can be easy to hear.

However, according to the audio reproducing device disclosed in JP-A 07-98933, since the audio data is divided into frames by the predetermined time and the part of the frame is superimposed onto the adjacent frame, it is necessary to hold a plurality of frames to be superimposed. In addition, when a reproduction speed is continuously switched, it cannot be switched from the currently processed frame, so that a time lag is generated when the equimultiple-speed reproduction is switched to the high-speed reproduction.

In addition, when recorded moving image data comprising audio data and video data is reproduced from the storage medium such as the DVD or the CD or the communication network, since the data comprises compressed audio data and compressed video data in general, it is necessary to decode the above. According to the audio reproducing device disclosed in JP-A 07-98933, it is necessary to hold the plurality of frames of the decoded audio data, and it is necessary to decode the plurality of frames of the audio data needed for high-speed reproduction at a new reproduction speed and hold them in a plurality of frame buffer memories when the reproduction speed is continuously switched.

### SUMMARY OF THE INVENTION

The present invention has been made in view of the above problems and it is an object of the present invention to provide a high-speed reproducing device in which transition of a reproduction speed between equimultiple-speed reproduction and high-speed reproduction can be smoothly performed and noise is not generated.

In order to attain the above object, an audio high-speed reproducing device according to the present invention can reproduce audio data at high speed and is characterized by comprising setting means for dividing each frame which constitutes the audio data and setting an object portion to be processed for each of a divided first-half block and a second-half block according to a reproduction speed of the audio data, and high-speed reproduction frame generating means for generating a high-speed reproduction frame in such a manner that the object portion to be processed of the first-half block is attenuated so that its attenuation rate gradually becomes high and the object portion to be processed of the second-half block is attenuated so that its attenuation rate gradually becomes low, and the attenuated object portion of the first-half block is superimposed onto the attenuated object portion of the second-half block.

The audio high-speed reproducing device according to the present invention is characterized in that the setting means deletes a predetermined portion from each frame which constitutes the audio data and divides the frame from which the predetermined portion has been deleted to set an object portion to be processed for the divided first-half block and second-half block, according to the reproduction speed.

In addition, the audio high-speed reproducing device according to the present invention to attain the above object is characterized in that the setting means divides the high-speed reproduction frame generated by the high-speed reproduction frame generating means and sets an object portion to be processed for the divided first-half block and second-half block, according to the reproduction speed, and the high-speed reproduction frame generating means generates the high-speed reproduction frame by attenuating each of the object portions to be processed set for the high-speed reproduction frame and superimposing the attenuated object portions.

Furthermore, another audio high-speed reproducing device according to the present invention can reproduce audio data at high speed and is characterized by comprising reproduction speed switching means for gradually switching a reproduction speed of the audio data between equimultiple-speed reproduction and the high-speed reproduction, setting means for dividing each frame which constitutes the audio data and setting an object portion to be processed for each of a divided first-half block and a second-half block according to the reproduction speed switched by the reproduction speed switching means, and high-speed reproduction frame generating means for generating a high-speed reproduction frame in such a manner that the object portion to be processed of the first-half block is attenuated so that its attenuation rate gradually becomes high and the object portion to be processed of the second-half block is attenuated so that its attenuation rate gradually becomes low, and the attenuated object portion of the first-half block is superimposed onto the attenuated object portion of the second-half block.

The audio high-speed reproducing device according to any one of the characteristics of the present invention is characterized by comprising a buffer memory which stores the audio data temporally, wherein one frame of the audio data is stored in the buffer memory when the high-speed reproduction of the audio data is requested.

The audio high-speed reproducing device according to the characteristics of the present invention is characterized by comprising decoding means for decoding the audio data when the audio data is compressed, wherein the audio data after decoded by the decoding means is stored in the buffer memory and one frame of the audio data is stored in the buffer memory.

The audio high-speed reproducing device according to the characteristics of the present invention is characterized by comprising decoding means for decoding the audio data for every frame when the audio data is compressed.

The audio high-speed reproducing device according to any one of the characteristics of the present invention is characterized by comprising receiving means for receiving moving image data including video data and the audio data, separating means for separating the moving image data into the video data and the audio data, and moving image reproducing means for reproducing the video data and the audio data synchronized with each other at high speed when the high-speed reproduction of the audio data is requested.

In addition, the audio high-speed reproducing device according to any one of the characteristics of the present invention is characterized by comprising audio reproducing means for reproducing the audio data when the audio data is individual audio data of each voice constituting multiplex voice, wherein the setting means sets an object portion to be processed for every individual audio data.

Another audio high-speed reproducing device according to any one of the characteristics of the present invention is characterized by comprising audio reproducing means for reproducing the audio data when the audio data is individual audio data of each voice constituting multiplex voice, wherein the setting means selects certain individual audio data and sets an object portion to be processed in the selected individual audio data.

Here, the multiplex voice includes the surround sound or a main and a sub sounds in bilingual broadcasting, and the individual audio data includes data of each speaker which constitutes the audio data of the surround sound, main sound data which constitutes the audio data for the bilingual broadcasting and the like.

According to the audio high-speed reproducing device of the present invention, when the audio data is reproduced at high speed, since the superimposing process is partially performed in a frame at the time of high-speed reproduction of the audio data, it is not necessary to hold anterior and posterior frames, so that the high-speed reproduction can be performed from the currently processed frame. Therefore, the transition from the equimultiple-speed reproduction to the high-speed reproduction can be smoothly performed without any time lag. Especially, in a case where the audio data is compressed by a audio compressing technique such as MPEG (Moving Picture Experts Group), since the compressed audio data is decoded every frame in general, when the frames are superimposed, it is necessary to decode the anterior and posterior frames. According to the audio high-speed reproducing device of the present invention, since the superimposing process is performed in the frame, it is not necessary decode the anterior and posterior frames of the frame to be processed again at the time of switching of the reproduction speed, so that the decoding process of the audio data can be minimized.

In addition, since the frame is divided into the first-half block and the second-half block and the first-half block is faded out so that the attenuation rate gradually becomes high, and the second-half block is faded in so that the attenuation rate gradually becomes low, and the faded-out first-half block and the faded-in second-half block are superimposed, the data of both ends of the frame can be the same value of that of the data before processed. In this constitution, noise can be prevented from being generated between the adjacent frames.

Furthermore, since the attenuation process is performed for one frame (data for a constant period) of the audio data in the frame, and audio data of a different timing is partially superimposed, the sound is prevented from being cut or noise is prevented from being generated, which is caused when the frame is partially removed at the time of double-speed reproduction of the voice. As a result, there can be provided an audio high-speed reproducing device in which the sound is audible even when it is reproduced at high speed.

An audio high-speed reproduction method according to the present invention is a method in an audio high-speed reproducing device which can reproduce audio data at high speed and characterized by comprising a setting step of dividing each frame which constitutes the audio data and setting an object portion to be processed for each of a divided first-half block and a second-half block according to a reproduction speed of the audio data, and a high-speed reproduction frame generating step of generating a high-speed reproduction frame, in which the object portion to be processed of the first-half block is attenuated so that its attenuation rate gradually becomes high and the object portion to be processed of the second-half block is attenuated so that its attenuation rate gradually becomes low, and the attenuated object portion of the first-half block is superimposed onto the attenuated object portion of the second-half block.

According to the audio high-speed reproducing method of the present invention, all of the above working effects in the audio high-speed reproducing device of the present invention can be provided and since the process is performed in one frame, the transition from the equimultiple-speed reproduction to the high-speed reproduction can be smoothly performed without any time lag, and the process for the high-speed reproduction can be simplified without considering the anterior and posterior frames in the process for the high-speed reproduction.

In addition, an audio high-speed reproduction program of the present invention is characterized by comprising a program step of executing the function of each means in the audio high-speed reproducing device according to any one of the characteristics of the present invention on a computer.

According to the audio high-speed reproducing program of the present invention, all of the above working effects in the audio high-speed reproducing device of the present invention can be provided and since the process is performed in one frame, the transition from the equimultiple-speed reproduction to the high-speed reproduction can be smoothly performed and the process for the high-speed reproduction can be simplified to facilitate the generation of the audio high-speed reproduction program.

### BRIEF DESCRIPTION OF THE DRAWINGS

FIG. 1 is a block diagram showing a constitution of an audio high-speed reproducing device according to one embodiment of the present invention;

FIG. 2 is a schematic view to explain frame processing at the time of 1.33× speed reproduction;

FIG. 3 is a schematic view to explain frame processing at the time of 2× speed reproduction;

FIG. 4 is a schematic view to explain frame processing at the time of 4× speed reproduction;

FIG. 5 is a schematic view to explain another frame processing at the time of 4× speed reproduction;

FIG. 6 is a schematic view to explain frame processing at the time of gradual transition of a reproduction speed;

FIG. 7 is a flowchart showing frame processing of the audio high-speed reproducing device according to the present invention;

FIG. 8 is a flowchart showing frame processing at the time of high-speed reproduction:

FIG. 9 is a flowchart showing frame processing at the time of gradual transition to the high-speed reproduction;

FIG. 10 is a block diagram showing a constitution when the audio high-speed reproducing device according to the present invention is applied to an audio device;

FIG. 11 is a flowchart showing frame processing when the audio high-speed reproducing device according to the present invention is applied to an audio device;

FIG. 12 is a flowchart showing frame processing at the time of high-speed reproduction when the audio high-speed reproducing device according to the present invention is applied to an audio device; and

FIG. 13 is a flowchart showing frame processing at the time of gradual transition to the high-speed reproduction when the audio high-speed reproducing device according to the present invention is applied to an audio device.

### DETAILED DESCRIPTION OF THE INVENTION

An embodiment of an audio high-speed reproducing device according to the present invention (referred to as the device of the present invention occasionally hereinafter) will be described with reference to the drawings.

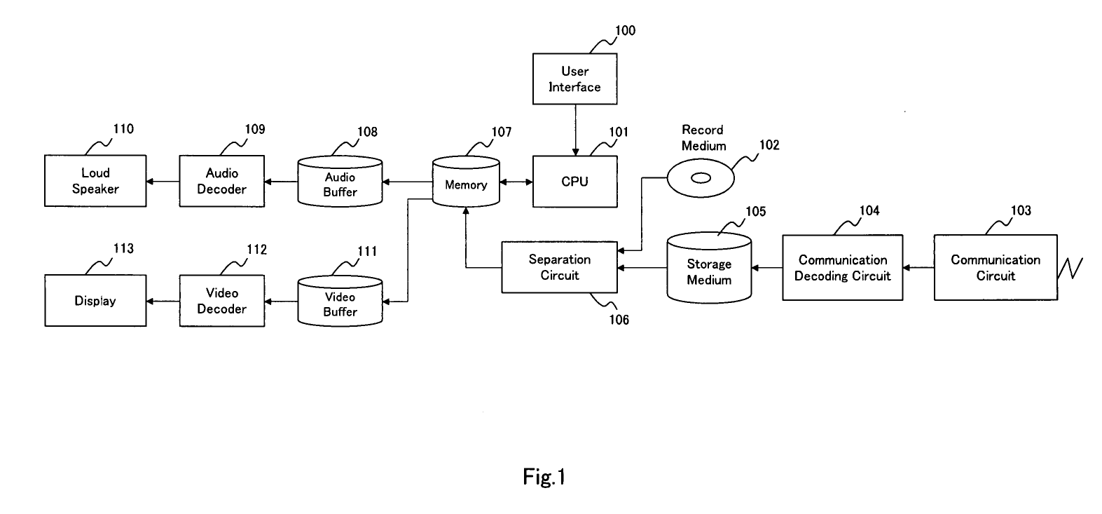

The audio high-speed reproducing device according to this embodiment is applied to a DVD (Digital Versatile Disk)/HDD (Hard Disk Drive) recording and reproducing device and as shown in FIG. 1, it comprises a function to read data from a storage medium 102 such as a DVD or a CD, a communication circuit 103 to receive data from a communication network, a communication decoding circuit 104 which decodes the received data, a storage medium 105 such as a HDD to record the data from the communication network, a separation circuit 106 to separate the read-out data to audio data and video data, a buffer memory 107 to store the separated audio data and video data temporally, a CPU 101 comprising means for controlling the entire device of the present invention and decoding means when the audio data and the video data are compressed, an audio buffer 108 and an audio decoder 109 and a speaker 110 to reproduce the decoded audio data, and a video buffer 111 and a video decoder 112 and a display 113 to display the decoded video data.

The CPU 101 serving as a central processing unit controls the entire DVD/HDD recording and reproducing device and decodes the audio data and the video data and superimposes the audio data at the time of high-speed reproduction using the buffer memory 107. In addition, the CPU 101 transfers the decoded audio data and video data from the buffer memory 107 to the audio buffer 108 and the video buffer 111, respectively.

In addition, according to this embodiment, the audio data read from the storage medium 102 or 105 is compressed by a compression method in ISO (International Organization for Standardization) such as MP3 or AAC, and the video data is compressed by a compression method of media integrated video compression such as H.264 or MPEG4. The CPU 101 decodes the audio data and the video data every frame and stores them in the buffer memory 107.

In addition, the function of the CPU 101 according to the present invention comprises setting means for dividing each frame which constitutes the audio data according to a reproducing speed of the audio data, and setting object portions to be processed in a divided first-half block and a second-half block, and high-speed reproduction frame generating means for generating a high-speed reproduction frame by performing an attenuation process for the object portion to be processed in the first block so that an attenuation rate gradually becomes high and performing an attenuation process for the object portion to be processed in the second-half block so that the attenuation rate gradually becomes low, and superimposing the attenuated object portion in the first-half block onto the attenuated object portion in the second-half block.

The audio decoder 109 converts the audio data transferred to the audio buffer 108 by the CPU 101 to an analog audio signal and the analog audio signal is outputted to the speaker 110 and the like to be reproduced. The video decoder 112 converts the video data transferred to the video buffer 111 by the CPU 101 to a video signal and the video signal is outputted to the display 113 and the like to be reproduced and displayed.

Here, in a case of the reproduction at a normal speed (equimultiple speed), the audio data compressed by a standard compression method such as AAC is decoded every 2048 samples of one frame and reproduced at a predetermined sampling frequency such as 48000 Hz.

In addition, when the audio data is reproduced at a speed higher than the normal speed (equimultiple speed), since the audio data of one frame decoded by the CPU 101 is stored in the buffer memory 107, the audio data is attenuated and superimposed according to a reproducing speed requested by a host or a user and transferred to the audio buffer 108, so that the high-speed reproduction is implemented.

Next, a concrete superimpose process of the audio data at the speed higher than the normal speed (equimultiple speed) will be described. In addition, the DVD/HDD recording and reproducing device according to this embodiment is so constituted that 1.33 (4/3)× speed reproduction, 2× speed reproduction, 4× speed reproduction and gradual transition to the high-speed reproduction of the audio data and the video data can be designated. Here, the audio data of one frame decoded by the CPU 101 consists of the 2048 samples and each sample has a bit width of 16 bits. Here, the attenuation process in which the attenuation rate becomes gradually high (referred to as the fade-out process hereinafter) is performed for the first-half object portion to be superimposed, and the attenuation process in which the attenuation rate becomes gradually low (referred to as the fade-in process hereinafter) is performed for the second-half object portion to be superimposed. In addition, the attenuation rate of each sample is set so that the bit width of each sample after attenuated and superimposed may not exceed an original sample bit width, that is, 16 bits.

First Processing Mode

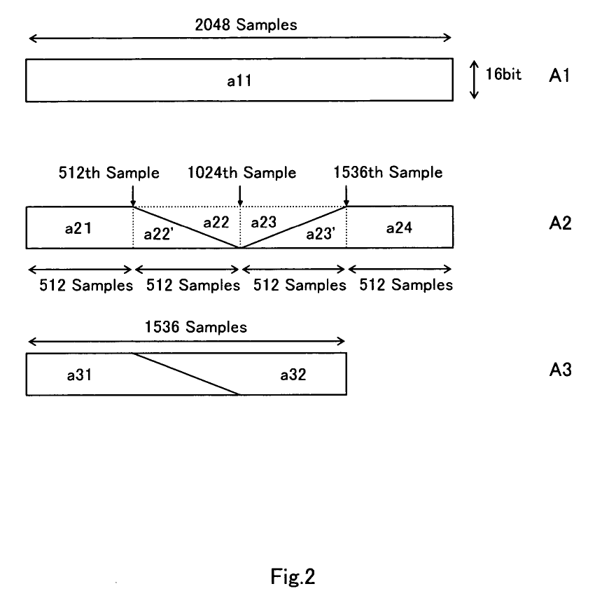

First, the case of the 1.33 (4/3)× speed reproduction will be descried with reference to FIG. 2. Here, the attenuation process is performed for the samples from the 512th sample to the 1535th sample among the 2048 samples and they are superimposed (added) to implement the 1.33(4/3)× speed reproduction.

The 1.33× speed reproduction is designated by the host or the user. Which sample is how much attenuated and superimposed is calculated from the “designated reproduction speed” and “the number of samples per frame” by the CPU 101. More specifically, the number of samples to be superimposed is set so that a size of the superimposed frame may become (the number of samples per frame)×(1/reproduction speed). In the case of the 1.33(4/3)× speed reproduction, the number of samples after superimposed is set at 1536 samples (=2048 samples×(1/1.33)). The number of samples to be superimposed is 512×2. Here, when it is assumed that 100 frames of the audio data are reproduced at 1.33 (4/3)× speed, the number of samples of the audio data is reduced so that 204800 samples (=100×2048 samples) becomes 153600 samples (100×1536 samples) in the 1.33 (4/3)× speed reproduction process. Thus, since the number of samples to be processed by the audio decoder becomes 3/4, the sound outputted from the speaker is reproduced at the 1.33 (4/3)× speed.

Then, the attenuation process for the frame and the superimpose process for the frames will be described in detail with reference to FIG. 2.

A state A1 shows a state of decoded audio data stored in the buffer memory 107, that is, a block all consisting of the 2048 samples.

A state A2 shows a state in which the block all in the state A1 is divided into two blocks having the same number of samples, and an object portion to be processed of 512 samples is set in each of the first-half block and the second-half block and attenuated. More specifically, a block a21 comprises the 0th sample to the 511th sample, a block a22 comprises the 512th sample to the 1023th sample, a block a23 comprises the 1024th sample to 1535th sample, a block a24 comprises the 1536th sample to 2047th sample, and the block a22 and the block a23 are the object portions to be processed. In addition, the block a21 and the block a24 are not attenuated and the values of those are used as it is, and the block a22 and the block a23 to be processed are attenuated. States of the block a22 and the block a23 gradually attenuated are shown as a block a22′ and a block a23′, respectively. More specifically, the fade-out process is performed for the block a22. The 512th sample is attenuated to 511/512 of its original value, the next 513th is attenuated to 510/512 of its original value, the 514th sample is attenuated to 509/512 of its original value, and so on. Finally, the 1023th sample is attenuated to 1/512 of its original value. In addition, the fade-in process is performed for the block a23. The 1024th sample is attenuated to 1/512, the 1025th sample is attenuated to 1/512, and so on. Finally, the 1535th sample is attenuated to 511/512.

A state A3 shows a state in which the block a21 and the block a22 in the state A2 are set to a block a31 and the block a23 and the block a24 in the state A2 are set to a block a32 and the block a31 comprising the 512th sample to the 1023th sample are superimposed (added) onto the block a32 comprising the 1024th sample to the 1535th sample. Thus, the state A3 shows that the 2048 samples are reduced to 1536 samples. Since the object portion to be processed is attenuated by setting the attenuation rate so that a bit width of the superimposed sample may be the same bit width of 16 bits of the original sample, the bit width does not exceed 16 bits. In addition, since a boundary part with another frame has the same mass as that of the original sample, noise can be prevented.

Second Processing Mode

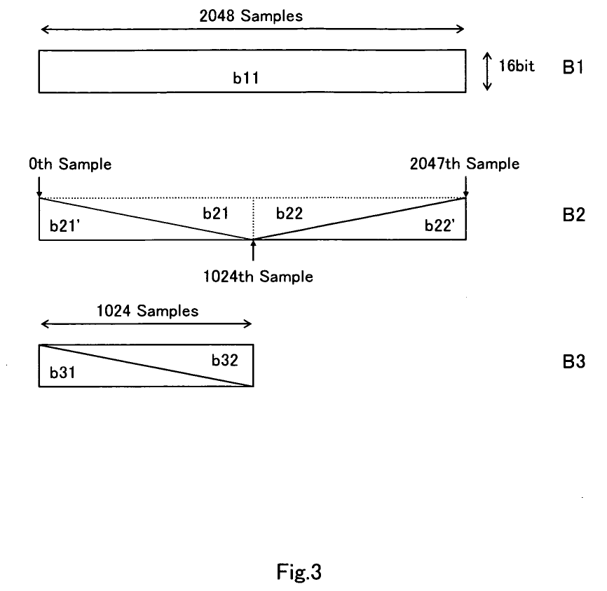

Next, the case of 2× speed reproduction will be described with reference to FIG. 3. Here, the entire 2048 samples are attenuated and superimposed (added) to implement the 2× speed reproduction.

The 2× speed reproduction is designated by the host or the user. Which sample is how much attenuated and superimposed is calculated from “the designated reproduction speed” and “the number of samples per frame” by the CPU 101 like the case of the 1.33× speed reproduction. In the case of the 2× speed reproduction, the number of samples after superimposed is set at 1024 samples (=2048 samples×(½)). The number of samples to be superimposed is 1024. Here, when it is assumed that 100 frames of the audio data are reproduced at the 2× speed, the number of the samples is reduced so that 204800 samples (=100×2048 samples) becomes 102400 samples (=100×1024 samples) in the 2× speed reproduction process. Thus, since the number of samples to be processed by the audio decoder becomes ½, the sound is reproduced from the speaker at the 2× high speed.

Then, the attenuation process of the frame and the superimpose process of the frames will be described in detail with reference to FIG. 3.

A state B1 shows a state of decoded audio data stored in the buffer memory 107, that is, a block b11 consisting of the 2048 samples.

A state B2 shows a state in which the block b11 in the state B1 is divided into two blocks having the same number of samples, and the 1024 samples in each of the first-half block and the second-half block are set to be processed and attenuated. Here, the entire first-half block and the entire second-half block are processed. More specifically, the block b11 is divided into a block b21 comprising the 0th sample to the 1023th sample, and a block b22 comprising the 1024th sample to the 2047th sample and the entire block b21 and the entire block b22 are set to be processed and attenuated. States after each sample in the block b21 and each sample in the block b22 are gradually attenuated are shown as a block b21′ and a block b22′, respectively. More specifically, the block b21 is faded out. The 0th sample is attenuated to 1023/1024 of its original value, the next first sample is attenuated to 1022/1024 of its original value, the second sample is attenuated to 1021/1024 of its original value, and so on. Finally, the 1023th sample is attenuated to 1/1024 of its original value. In addition, the block b22 is faded in. The 1024th sample is attenuated to 1/1024 of its original value, the 1025th sample is attenuated to 2/1024 of its original value, and so on. Finally, the 2047th sample is attenuated to 1023/1024 of its original value.

A state B3 shows a state in which the block 21′ comprising the 0th sample to the 1023th sample which was attenuated in the state B2 is set to a block b31, and the attenuated block b22′ comprising 1024th sample to 2047th sample is set to a block b32 and the block b31 is superimposed (added) onto the block b32. Thus the state B3 shows that the 2048 samples are reduced to 1024 samples. Since the object portion to be processed is attenuated by setting the attenuation rate so that a bit width of the superimposed sample may be the same bit width of 16 bits of the original sample, the bit width does not exceed 16 bits. In addition, since a boundary part with another frame has the same mass as that of the original sample, noise can be prevented.

Third Processing Mode

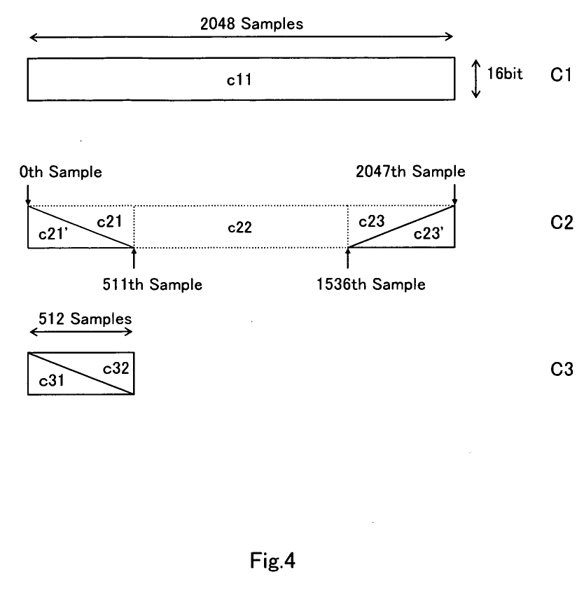

Next, the case of 4× speed reproduction will be described with reference to FIG. 4. Here, a predetermined portion is deleted from each frame constituting the audio data according to the reproduction speed, and the frame after a part of which is deleted is divided into a first-half block and a second-half block to be processed.

The 4× speed reproduction is designated by the host or the user like in the case of the first processing. Which sample is how much attenuated and superimposed is calculated from the “designated reproduction speed” and “the number of samples per frame” by the CPU 101. In the case of the 4× speed reproduction, the number of samples after superimposed is set at 512 samples (=2048 samples×(¼)). In this case, the number of samples to be superimposed is set at 512×2 and the remaining 1024 samples are deleted. Here, when it is assumed that 100 frames of the audio data are reproduced at the 4× speed, the number of the samples of the audio data is reduced so that 204800 samples (=100×2048) becomes 51200 samples (=100×512) in the 4× speed reproduction process. Thus, since the number of samples to be processed by the audio decoder becomes ¼, the sound is reproduced from the speaker at the 4× high speed.

Then, the attenuation process of the frame and the superimpose process of the frames in the 4× speed reproduction will be described in detail with reference to FIG. 4.

A state C1 shows a state of a decoded audio data stored in the buffer memory 107, that is, a block c11 consisting of the 2048 samples.

A state C2 shows a state in which the block c11 in the state C1 is divided into the block to be deleted and two blocks having the same number of samples of 512 to be processed, and the object portion to be processed is attenuated. More specifically, the block c11 is divided into a block c21 comprising the 0th sample to the 511th sample to be processed, a block c22 comprising the 512th sample to the 1535th to be deleted, and a block c23 comprising the 1526th sample to the 2047th sample to be processed. Then, the block c22 is deleted and the block c21 and the block c23 are attenuated. The block c21 and the block c23 are gradually attenuated and become a block c21′ and a block c22′, respectively. The block c21 is faded out. That is, the 0th sample is attenuated to 511/512 of its original value, the next first sample is attenuated to 510/512 of its original value, the second sample is attenuated to 509/512 of its original value, and so on. Finally, the 511th sample is attenuated to 1/512 of its original value. In addition, the block c23 is faded in. The 1536th sample is attenuated to 1/512, the 1537th sample is attenuated to 2/512, and so on. Finally, the 2047th sample is attenuated to 511/512.

A state C3 shows a state in which the block c21′ comprising the 0th sample to the 511th sample which were attenuated in the state C2 is set to a block c31, and the attenuated block c23′ comprising 1536th sample to 2047th sample is set to a block c32 and the block c31 is superimposed (added) onto the block c32. Thus, the state C3 shows that the 2048 samples are reduced to 512 samples. Since the object to be processed is attenuated by setting the attenuation rate so that a bit width of the superimposed sample may be the same bit width of 16 bits of the original sample, the bit width does not exceed 16 bits. In addition, since a boundary part with another frame has the same mass as that of the original sample, noise can be prevented.

Fourth Processing Mode

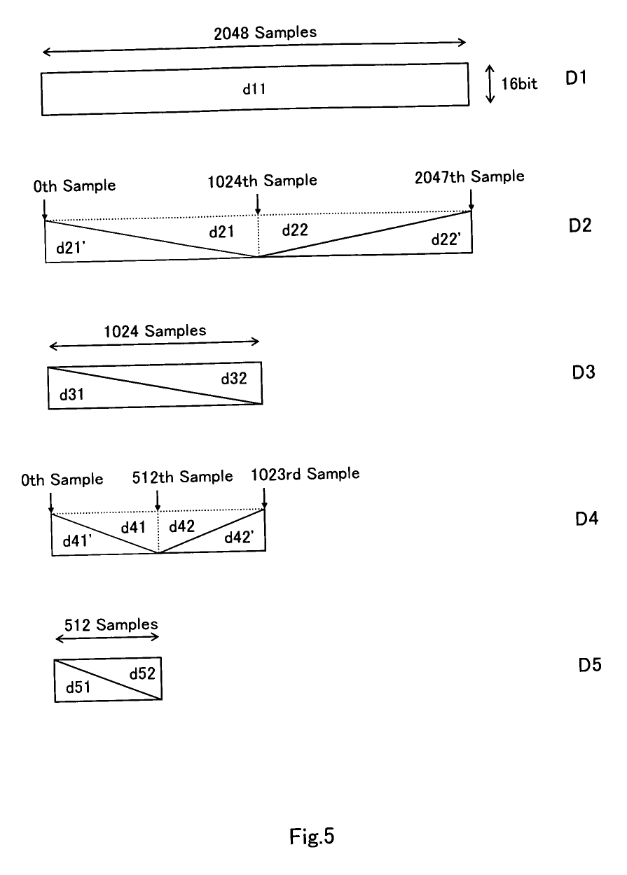

Next, another processing mode of the 4× speed reproduction will be described with reference to FIG. 5. Although the predetermined portion of the frame is deleted and the remaining part is processed to implement the 4× speed reproduction in the above third processing mode, according to this processing mode, the CPU 101 repeats the attenuation process and the superimpose process for the same frame to perform the 4× speed reproduction. In addition, the number of the attenuation processes and the superimpose processes is set depending on the reproduction speed.

The 4× speed reproduction is designated by the host or the user like the first to third processing mode. Which sample is how much attenuated and superimposed is calculated from “the designated reproduction speed” and “the number of samples per frame” by the CPU 101. In the 4× speed reproduction in this case, the frame generated in the 2× speed reproduction of the second processing mode is further attenuated and superimposed to implement the 4× speed reproduction. Here, when it is assumed that 100 frames of the audio data are reproduced at the 4× speed, the number of the samples is reduced so that 204800 samples (=100×2048 samples) become 51200 samples (=100×512 samples) in the 4× speed reproduction process. Thus, since the number of samples to be processed by the audio decoder becomes ¼, the audio is reproduced from the speaker at the 4× high speed.

Then, the attenuation process of the frame and the superimpose process of the frames in the 4× speed reproduction will be described in detail with reference to FIG. 5.

A state D1 shows a state of a decoded audio data stored in the buffer memory 107, that is, a block d11 consisting of the 2048 samples.

A state D2 shows a state in which the block d11 in the state D1 is divided into a block d21 comprising the 0th sample to the 1023th sample, and a block d22 comprising the 1024th sample to the 2047th sample and block d21 and block d22 are set as the object portion to be processed and attenuated. States after the block d21 and the block b22 are attenuated in stages are shown as a block d21′ and a block d22′, respectively. More specifically, the block d21 is faded out. That is, the 0th sample is attenuated to 1023/1024 of its original value, the first sample is attenuated to 1022/1024, the second sample is attenuated to 1021/1024, and so on. Finally, the 1023th sample is attenuated to 1/1024. In addition, the block d22 is faded in. The 1024th sample is attenuated to 1/1024 of its original value, the 1025th sample is attenuated to 2/1024, and so on. Finally, the 2047th sample is attenuated to 1023/1024.

A state D3 shows a state in which the block d21′ comprising the 0th sample to the 1023th sample which were attenuated in the state D2 is set to a block d31, and the attenuated block d22′ comprising 1024th sample to 2047th sample is set to a block d32 and the block d31 is superimposed (added) onto the block d32. Thus, the state D3 shows that the 2048 samples are reduced to 1024 samples.

A state D4 shows a state in which the 1024 samples in the state D3 are divided into a block d41 comprising 0th sample to the 511th sample and a block d42 comprising the 512th sample to the 1023th sample, and the entire block d41 and block d42 are set as the object portions to be processed and attenuated. States after the block d41 and the block d42 are attenuated in stages are shown as a block d41′ and a block d42′, respectively. More specifically, the block d41 is faded out. That is, the 0th sample is attenuated to 511/512 of its original value, the first sample is attenuated to 510/512 of its original value, the second sample is attenuated to 509/512, and so on. Finally, the 511th sample is attenuated to 1/512. In addition, the block d42 is faded in. That is, the 512th sample is attenuated to 1/512, the 513th sample is attenuated to 2/512, and so on. Finally, the 1023th sample is attenuated to 511/512.

A state D5 shows a state in which the block d41′ comprising the 0th sample to the 511th sample which were attenuated in the state D4 is set to a block d51, and the attenuated block d42′ comprising 1536th sample to 2047th sample is set to a block d52 and the block d51 is superimposed (added) onto the block d52. Thus, the state D5 shows that the 1024 samples are reduced to 512 samples. Since the object to be processed is attenuated by setting the attenuation rate so that a bit width of the superimposed sample may be the same bit width of 16 bits of the original sample, the bit width does not exceed 16 bits. In addition, since a boundary part with another frame has almost the same mass as that of the original sample, noise can be prevented.

Fifth Processing Mode

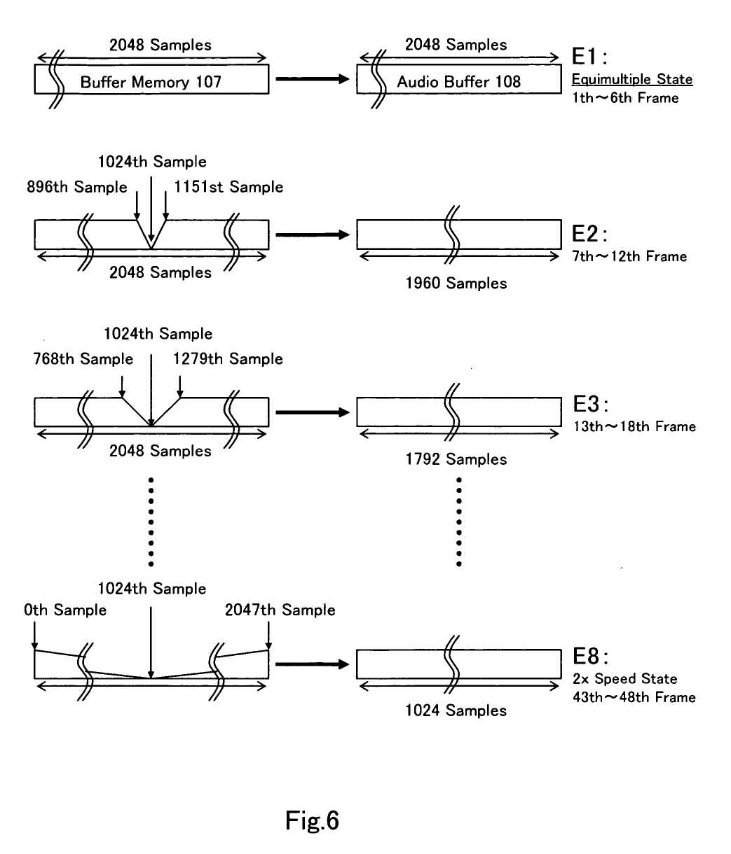

Next, a case of gradual transition to high-speed reproduction will be described with reference to FIG. 6. Although the description has been made of the case where the high-speed reproduction is implemented at the predetermined reproduction speed in the above first to fourth processing mode, in this embodiment, the CPU 101 comprises a function as reproduction speed switching means for switching the reproduction speed of the audio data between the equimultiple-speed reproduction and the high-speed reproduction in stages so that the reproduction speed becomes gradually high, and divides each frame constituting the audio data according to the switched reproduction speed and sets an object portion to be processed in each of the divided first-half block and second-half block.

When the gradual transition to the high-speed reproduction is designated by the host or the user, which sample is how much attenuated and superimposed is calculated from “a length of time for the transition to the high speed reproduction” “the number of stage to be taken to transit to the high-speed reproduction” “the designated reproduction speed” and “the number of samples per frame” by the CPU 101.

Here, a case of transition to the 2× speed reproduction in stages will be described. More specifically, as shown in FIG. 6, it takes 10 seconds to implement transition from a normal reproduction state E1 to a 2× speed reproduction state E8 taking eight stages. In a case where surround sound having a width of 16 bits is reproduced at 48000 Hz, when one frame comprises 2048 samples, it is necessary to process about 48 frames in 10 seconds, so that the 48 frames are gradually attenuated and superimposed every 6 frames.

The normal state E1 shows that the 2048 samples in the buffer memory 107 are transferred to the audio buffer as it is for the first 6 frames and reproduced at the normal speed.

A state E2 shows a state in which the 2048 samples are reduced to 1960 samples in each of the 7th to 12th frames which are stored temporally in the buffer memory 107, by the method of the present invention and then transferred to the audio buffer 108.

Furthermore, a state E3 shows a state in which the 2048 samples are reduced to 1792 samples in each of the 13th to 18th frames which are stored temporally in the buffer memory 107, by the method of the present invention and then transferred to the audio buffer 108.

The same processes are repeated to finally implement a state E in which the 2048 samples are reduced to 1024 samples in each of the 43th to 48th frames. Thus, as the reproduction speed of the audio data is picked up in stages, the audio data can be reproduced at higher speed without a sense of discomfort. In addition, when the gradual transition from the high-speed reproduction to the equimultiple-speed reproduction is designated, the processes from the state E1 to the state E8 are performed reversely to implement the gradual transition from the high-speed reproduction to the equimultiple-speed reproduction. As a result, the reproduction speed of the audio data can be gradually changed over between the equimultiple-speed reproduction and the high-speed reproduction.

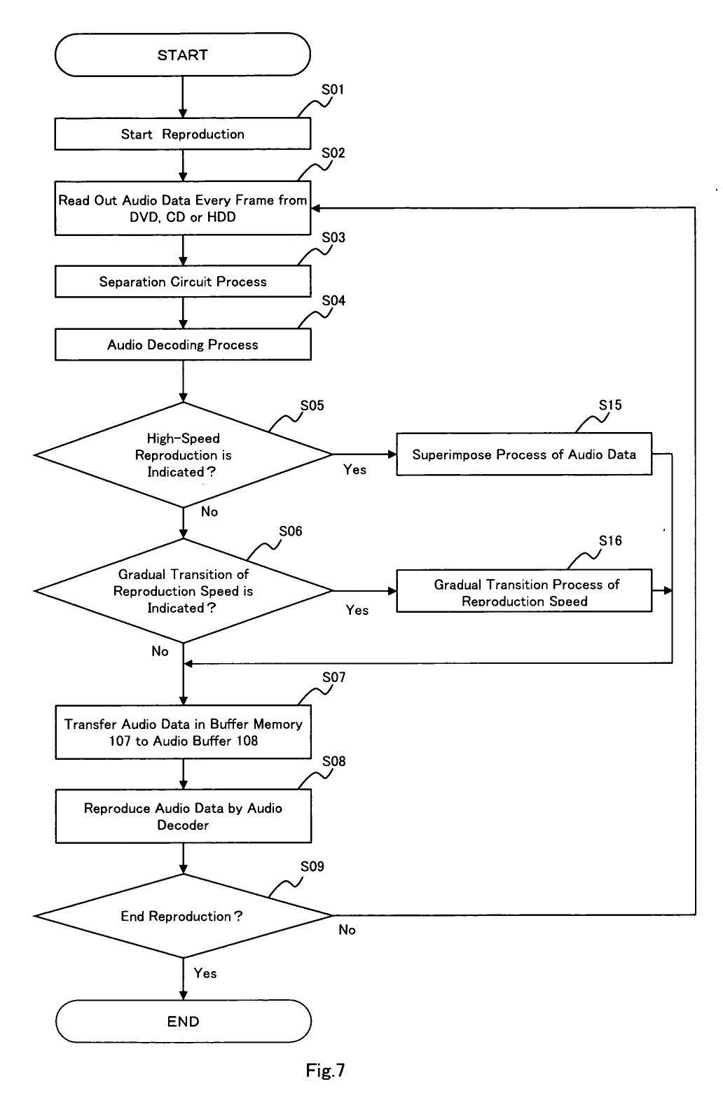

Next, operations of the audio reproducing process of the DVD/HDD recording and reproducing device according to the present invention will be described with reference to a flowchart shown in FIG. 7.

First, the device of the present invention stars reproduction of the audio data or the audio data and the video data according to a command from the host or the user in step S01. Then, the audio data is read out from the storage medium 102 such as the DVD or CD. Alternatively, the audio data or data containing the video data and the audio data stored in the storage medium 105 such as the HDD are read out in step S02. When the data read out from the storage medium 102 or 105 contains the video data and the audio data, the data is separated into the audio data and the video data in the separation circuit 106 and they are temporally stored in the buffer memory 107 in step S03. When the audio data temporally stored in the buffer memory 107 is compressed by the audio compression method such as MP3 or AAC, it is decoded by the CPU 101 in step S04.

Then, the CPU 101 determines whether the high-speed reproduction is indicated by the host or the user or not in step S05. When the high-speed reproduction is indicated, the operation is moved to step S15 and the superimpose process of the audio data as will be described below is performed. In addition, the CPU 101 determines whether the gradual transition of the reproduction speed is indicated by the host or the user or not in step S06 and when the gradual transition of the reproducing speed is indicated, the operation is moved to step S16 and the gradual transition process of the reproduction speed as will be described below is performed.

At the time of the equimultiple-speed reproduction, unprocessed audio data is stored in the buffer memory 107 and when the high-speed reproduction is indicated, the audio data in which the number of samples was reduced by the attenuation process and the superimpose process by the device of the present invention is stored in the buffer memory 107. The CPU 101 transfers the necessary samples of the audio data to the audio buffer 108 in step S07. The audio decoder 109 generates audio stored in the audio buffer 108 in step S08. Then, when the process is to be continued, the operation returns to the step S02 and the audio is repeatedly reproduced in step S09.

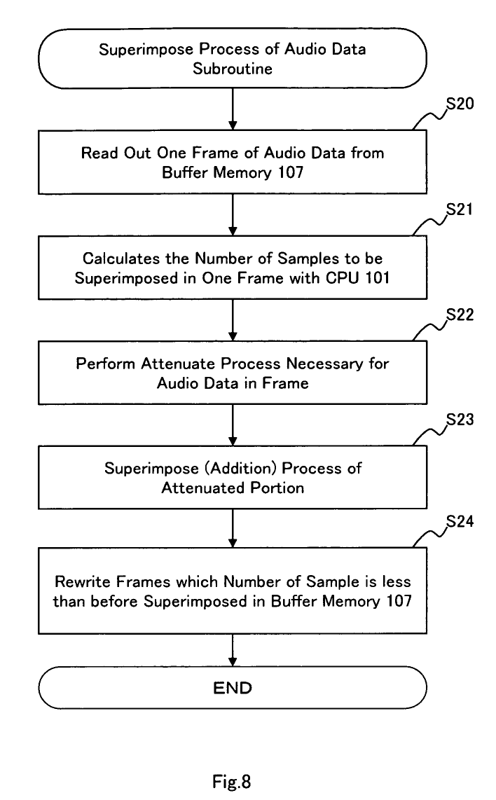

The superimpose process of the audio data at the time of the high-speed reproduction at the step S15 will be described in detail with reference to a flowchart shown in FIG. 8.

First, the CPU 101 reads out one frame of the audio data before the superimpose process is performed from the buffer memory 107 in step S20. Then, the CPU 101 calculates “the number of samples to be superimposed” for the read-out frame according to the high-speed reproduction speed at S21 and sets an object portion to be processed. The samples of the object to be processed in the read-out frame are attenuated in step S22. The attenuated frames are superimposed (added) in step S23. Finally, the superimposed frames are written again in the buffer memory 107 in step S24.

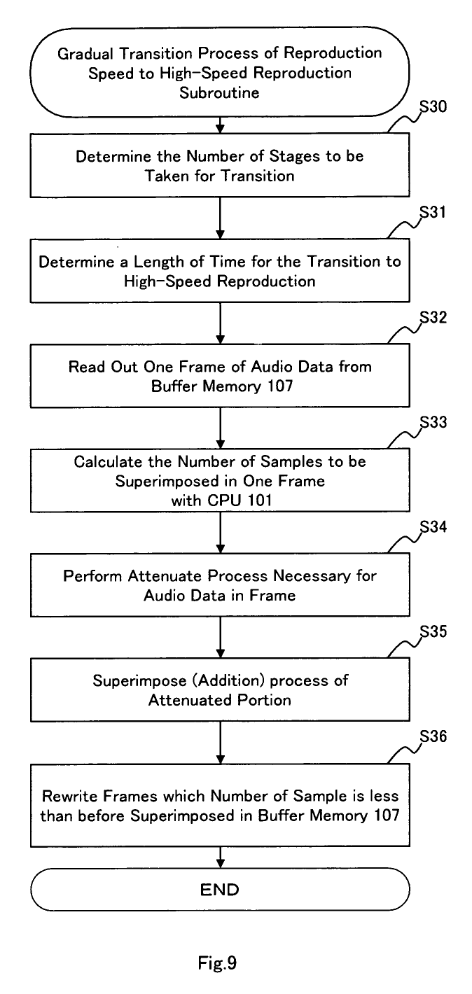

The gradual transition process of the reproduction speed at the step S16 will be described in detail with reference to a flowchart shown in FIG. 9.

First, in order to implement the gradual transition process of the reproduction speed, the CPU 101 determines “the number of stages to be taken to implement the transition” based on a value designated from the host or the user or a value previously set in the device of the present invention in step S30. Furthermore, “a length of time for the transition of the reproduction speed” is determined based on a value designated from the host or the user or a value previously set in the device of the present invention in step S31. Then, the CPU 101 reads out one frame of the audio data before the superimpose process is performed from the buffer memory 107 in step S32. The CPU 101 calculates “the number of samples to be superimposed” in the read-out frame based on “the number of stages to be taken to implement the transition” and “the length of time for the transition of the reproduction speed” in step S33. An object portion to be superimposed is set in the read-out frame and the samples to be processed are attenuated in step S34. Then, the attenuated frames are superimposed (added) in step S35. Finally, the superimposed frames are written again in the buffer memory 107 in step S36.

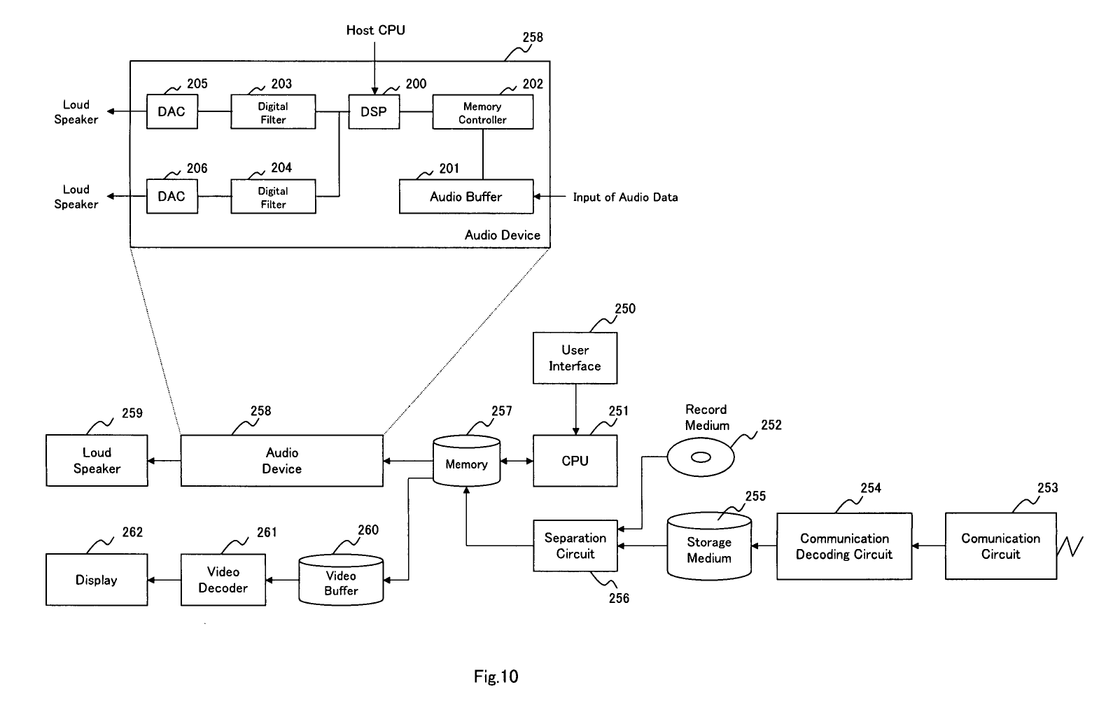

Next, another embodiment of the audio high-speed reproducing device according to the present invention will be described with reference to FIG. 10. According to this embodiment, a function of the audio high-speed reproducing device of the present invention is mounted as a function of an audio device.

According to this embodiment, instead of the audio buffer 108 and the audio decoder 109, an audio device 258 to attenuate and superimpose the audio data is provided. The audio device 258 comprises an audio buffer 201 as a buffer memory, a DSP 200 and a memory controller 202 to control the audio buffer 201, a digital filters 203 and 204, and DACs 205 and 206. In addition, according to this embodiment, in order to control the audio device 258, the CPU 251 instructs the high-speed reproduction, sets the gradual transition to the high-speed reproduction, and inputs the audio data and the like.

Furthermore, the audio high-speed reproducing device according to this embodiment comprises a function to read data from a storage medium 252 such as a DVD or a CD, a communication circuit 253 to receive data from a communication network, a communication decoding circuit 254 which decodes the received data, a storage medium 255 such as a HDD to record the data from the communication network, a separation circuit 256 to separate the read-out data to voice data and video data, a buffer memory 257 to store the separated voice data and video data temporally, the CPU 251 comprising means for controlling the entire device of the present invention and decoding means when the audio data and the video data are compressed, the audio device 258 and a speaker 259 to reproduce the decoded audio data, and a video buffer 260 and a video decoder 261 and a display 262 to display the decoded video data.

When the high-speed reproduction is designated by the host CPU, the DSP 200 receives the instruction of the high-speed reproduction from the host CPU 251 and sets a “reproduction speed”. The audio data inputted to the audio device 258 is temporally stored in the audio buffer 201 by the host CPU 251. The DSP 200 attenuates and superimposes the stored audio data and the superimposed audio data is rewritten in the audio buffer 201. Furthermore, the DSP 200 controls the memory controller 202 and the rewritten and superimposed audio data is transferred to the digital filter 203 every sample. The audio data is filtered by the digital filters 203 and 204 and converted to analog data by the DACs 205 and 206 and outputted to the speaker 259 to reproduce the audio. In the case of the surround sound, the above processes are performed alternately to reproduce the surround sound.

Here, the audio high-speed reproducing device according to this embodiment performs the same processes as the 1.33 (4/3)× speed reproduction process in the first processing mode, the 2× speed reproduction in the second processing mode, the 4× speed reproduction in the third processing mode, and the 4× speed reproduction in the fourth processing mode.

In addition, in the case the gradual transition to the high-speed reproduction is designated by the host CPU, when the “designated reproduction speed”, “the number of stages to be taken to transit to the high-speed reproduction”, “the length of time for transition to the high-speed reproduction” and the like are applied from the host CPU 259 to the DSP 200, the DSP 200 calculates the number of samples of the object portion to be attenuated and superimposed in the current frame stored in the audio buffer 201 so that the object portion in the frame is set. Furthermore, the DSP 200 reads out one frame of the audio data from the audio buffer 201 and attenuates and superimposes the frame and rewrites it in the audio buffer 201. Thus, the gradual transition to the high-speed reproduction can be implemented.

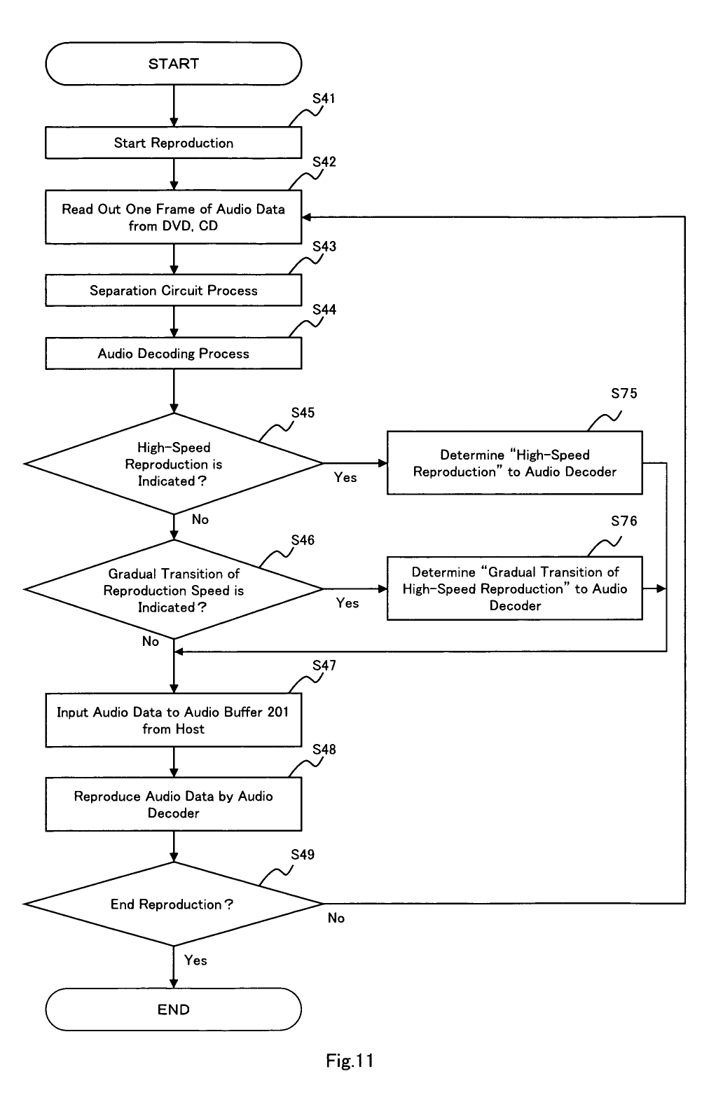

Next, an operation of the audio reproduction process of the device using the audio device 258 will be described in detail with reference to a flowchart shown in FIG. 11.

First, the device of the present invention starts reproduction of the audio data or the audio data and the video data according to a command by the host or the user in step S41. Then, the audio data is read out from the storage medium 252 such as the DVD or CD. Alternatively, the audio data or the video data and the audio data stored in the storage medium 255 such as the HDD are read out in step S42. When the data read out from the storage medium 252 or 255 contains the video data and the audio data, the data is separated into audio data and video data in the separation circuit 256 and they are temporally stored in the buffer memory 257 in step S43. When the audio data temporally stored in the buffer memory 257 is compressed by the audio compression method such as MP3 or AAC, it is decoded by the CPU 251 in step S44.

Then, it is determined whether the high-speed reproduction is indicated by the host CPU 251 or the user or not in step S45. When the high-speed reproduction is indicated, the operation is moved to step S75 and the “high-speed reproduction” is set to the audio device 258. That is, as will be described below, the “reproduction speed” is set to the DSP 200 of the audio device 258. In addition, it is determined whether the gradual transition to the high-speed reproduction is indicated by the host CPU 251 or the user or not in step S46 and when the gradual transition to the high-speed reproduction is indicated, the operation is moved to step S76 and the “gradual transition to the high-speed reproduction” is set to the audio device 258. That is, as will be described below, the “designated reproduction speed”, the “number of stages to be taken to transit to the high-speed reproduction”, the “length of time for transition to the high-speed reproduction” are set to the DSP 200 in the audio device 258.

Then, the host CPU 251 transfers the audio data from the buffer memory 257 to the audio device 258 in step S47. The audio device 258 generates written sound in step S48. Here, when the high-speed reproduction and the gradual transition to the high-speed reproduction are set, the audio device 258 superimposes the audio data. Then, when the operation is to be continued, the operation returns to the step S42 and the above audio reproduction is repeated in step S49.

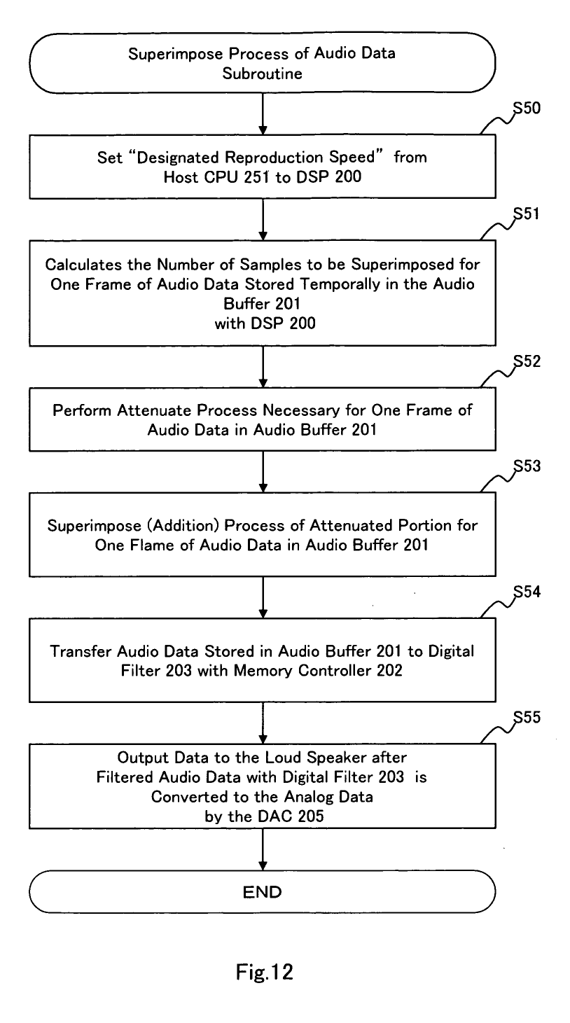

The operation at the time of high-speed reproduction of the audio device 258 at the step S75 will be described in detail with reference to a flow chart shown in FIG. 12.

First, the “reproduction speed” set by the host CPU 251 is set to the DSP 200 in step S50. Then, the DSP 200 calculates “the number of samples to be superimposed” for the frame stored in the audio buffer 201 according to the speed of the high-speed reproduction in step S51 and sets the object portion to be processed. Then, the samples to be processed which were set in the frame stored in the audio buffer 201 are attenuated in step S52. The attenuated frames are superimposed (added) in step S53. The superimposed frame is transferred to the digital filter 203 in step S54. Finally, the digital-filtered audio data is converted to the analog data by the DAC 205 and outputted to the speaker 259 in step S55.

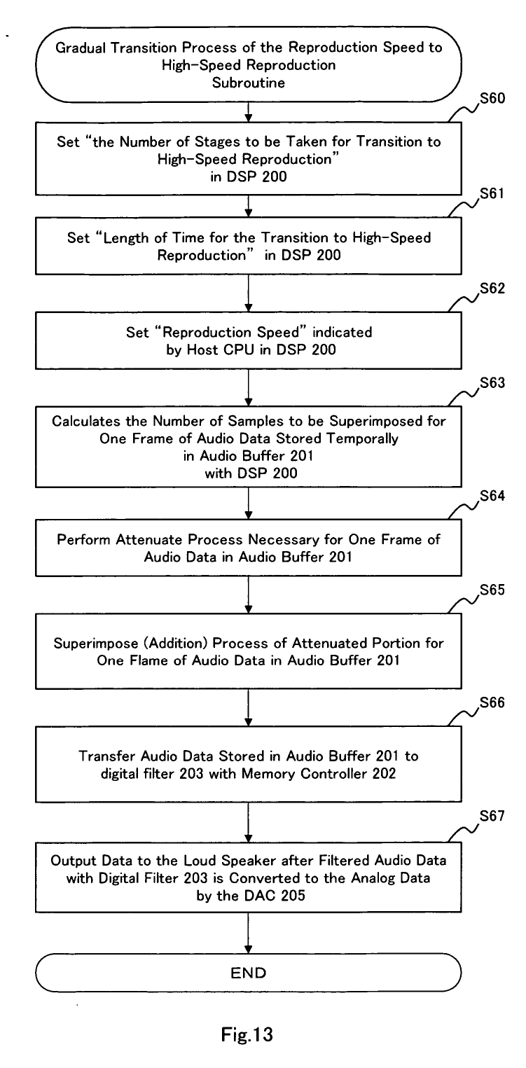

The operation of the gradual transition to the high-speed reproduction at the step S76 will be described in detail with reference to a flowchart shown in FIG. 13.

First, in order to implement the gradual transition to the high-speed reproduction, the DSP 200 determines the “number of stages to be taken for transition” based on a value designated from the host CPU 259 or the user or a value previously set in the DSP 200 in step S60. Furthermore, the DSP 200 determines the “length of time for the transition to the high-speed reproduction” based on a value designated from the host CPU 259 or the user or a value previously set in the DSP 200 in step S61. Then, the “reproduction speed” set by the host CPU 251 is set to the DSP 200 in step S62. The DSP 200 calculates “the number of samples to be superimposed” in the frame stored in the audio buffer 201 according to the speed of the high-speed reproduction in step S63. Then, the attenuation process is performed for the samples to be processed in the frame stored in the audio buffer 201 in step S64. The attenuated frames are superimposed (added) in step S65. The superimposed frame is transferred to the digital filter 203 in step S66. Finally, the digital-filtered audio data is converted to the analog data by the DAC 205 and outputted to the speaker 259 in step S67.

In addition, according to the embodiments, the DVD/HDD recording and reproducing device may comprise audio reproducing means for reproducing multiplex sound such as surround sound or bilingual broadcasting. In this case, the audio data comprises individual audio data of each sound constituting the multiplex sound such as data of each speaker constituting the audio data of the surround sound or main audio data constituting the audio data for the bilingual broadcasting. Thus, the above audio data is individually attenuated and superimposed. According to the preferable embodiment, the whole individual audio data may be attenuated and superimposed or certain individual data may be selected from the individual audio data to be attenuated and superimposed. For example, when the sound reproduced at the high-speed reproduction is only main sound in the bilingual broadcasting, only the individual audio data regarding the main sound may be attenuated and superimposed.

Although the audio high-speed reproducing device has been described in the above embodiments, the function of each means in the above audio high-speed reproducing device may be an audio high-speed reproduction program comprising program steps to be carried out in a computer. In this case also, since audio data is attenuated and superimposed in one frame of the audio data in order to implement high-speed reproduction of the sound at the time of high-speed reproduction, high-speed reproduction can be implemented along a time axis of the high-speed reproduction without interrupting the sound and without generating the noise. In addition, when the audio data compressed by the standard compression method such as AAC is reproduced at high speed, since the audio data in the one decoded frame is attenuated and superimposed, decoding for another frame is not needed. Therefore, since the high-speed reproduction can be performed from the frame to be processed at the present, the transition to the high-speed reproduction can be smoothly implemented without any time lag.

Although the present invention has been described in terms of a preferred embodiment, it will be appreciated that various modifications and alterations might be made by those skilled in the art without departing from the spirit and scope of the invention. The invention should therefore be measured in terms of the claims which follow.

What is claimed is:

1. An audio high-speed reproducing device which can reproduce audio data at high speed, comprising:
setting means for dividing each frame which constitutes the audio data and setting an object portion to be processed for each of a divided first-half block and a second-half block according to a reproduction speed of the audio data; and
high-speed reproduction frame generating means for generating a high-speed reproduction frame in such a manner that the object portion to be processed of the first-half block is attenuated so that its attenuation rate gradually becomes high and the object portion to be processed of the second-half block is attenuated so that its attenuation rate gradually becomes low, and the attenuated object portion of the first-half block is superimposed onto the attenuated object portion of the second-half block.

2. The audio high-speed reproducing device according to claim 1, wherein
the setting means deletes a predetermined portion from each frame which constitutes the audio data and divides the frame from which the predetermined portion has been deleted and sets the object portion to be processed for each of the divided first-half block and second-half block, according to the reproduction speed.

3. The audio high-speed reproducing device according to claim 1, wherein
the setting means divides the high-speed reproduction frame generated by the high-speed reproduction frame generating means and sets the object portion to be processed for each of the divided first-half block and second-half block, according to the reproduction speed, and
the high-speed reproduction frame generating means generates the high-speed reproduction frame by attenuating each of the object portions to be processed set in the high-speed reproduction frame and superimposing the attenuated object portions.

4. The audio high-speed reproducing device according to claim 1, comprising:
a buffer memory which stores the audio data temporally, wherein
one frame of the audio data is stored in the buffer memory when the high-speed reproduction of the audio data is requested.

5. The audio high-speed reproducing device according to claim 4, comprising:
decoding means for decoding the audio data when the audio data is compressed, wherein
the audio data after decoded by the decoding means is stored in the buffer memory and one frame of the audio data is stored in the buffer memory.

6. The audio high-speed reproducing device according to claim 4, comprising:
decoding means for decoding the audio data every frame when the audio data is compressed.

7. The audio high-speed reproducing device according to claim 1, comprising:
receiving means for receiving moving image data including video data and the audio data;
separating means for separating the moving image data into the video data and the audio data; and
moving image reproducing means for reproducing the video data and the audio data synchronized with each other at high speed when the high-speed reproduction of the audio data is requested.

8. The audio high-speed reproducing device according to claim 1, comprising:
audio reproducing means for reproducing the audio data when the audio data is individual audio data of each voice constituting multiplex voice, wherein
the setting means sets the object portion to be processed for every individual audio data.

9. The audio high-speed reproducing device according to claim 1, comprising:
audio reproducing means for reproducing the audio data when the audio data is individual audio data of each voice constituting multiplex voice, wherein
the setting means selects certain individual audio data and sets the object portion to be processed for the selected individual audio data.

10. An audio high-speed reproducing device which can reproduce audio data at high speed, comprising:
reproduction speed switching means for gradually switching a reproduction speed of the audio data between equimultiple-speed reproduction and the high-speed reproduction;
setting means for dividing each frame which constitutes the audio data and setting an object portion to be processed for each of a divided first-half block and a second-half block according to the reproduction speed switched by the reproduction speed switching means; and
high-speed reproduction frame generating means for generating a high-speed reproduction frame in such a manner that the object portion to be processed of the first-half block is attenuated so that its attenuation rate gradually becomes high and the object portion to be processed of the second-half block is attenuated so that its attenuation rate gradually becomes low, and the attenuated object portion of the first-half block is superimposed onto the attenuated object portion of the second-half block.

11. The audio high-speed reproducing device according to claim 10, comprising:
a buffer memory which stores the audio data temporally, wherein
one frame of the audio data is stored in the buffer memory when the high-speed reproduction of the audio data is requested.

12. The audio high-speed reproducing device according to claim 11, comprising:
decoding means for decoding the audio data when the audio data is compressed, wherein
the audio data after decoded by the decoding means is stored in the buffer memory and one frame of the audio data is stored in the buffer memory.

13. The audio high-speed reproducing device according to claim 11, comprising:
decoding means for decoding the audio data every frame when the audio data is compressed.

14. The audio high-speed reproducing device according to claim 10, comprising:
receiving means for receiving moving image data including video data and the audio data;
separating means for separating the moving image data into the video data and the audio data; and
moving image reproducing means for reproducing the video data and the audio data synchronized with each other at high speed when the high-speed reproduction of the audio data is requested.

15. The audio high-speed reproducing device according to claim 10, comprising:
audio reproducing means for reproducing the audio data when the audio data is individual audio data of each voice constituting multiplex voice, wherein
the setting means sets an object portion to be processed for every individual audio data.

16. The audio high-speed reproducing device according to claim 10, comprising:
audio reproducing means for reproducing the audio data when the audio data is individual audio data of each voice constituting multiplex voice, wherein
the setting means selects certain individual audio data and sets the object portion to be processed for the selected individual audio data.

17. An audio high-speed reproduction method in an audio high-speed reproducing device which can reproduce audio data at high speed, the method comprising:
a setting step of dividing each frame which constitutes the audio data and setting an object portion to be processed for each of a divided first-half block and a second-half block according to a reproduction speed of the audio data; and
a high-speed reproduction frame generating step of generating a high-speed reproduction frame in such a manner that the object portion to be processed of the first-half block is attenuated so that its attenuation rate gradually becomes high and the object portion to be processed of the second-half block is attenuated so that its attenuation rate gradually becomes low, and the attenuated object portion of the first-half block is superimposed onto the attenuated object portion of the second-half block.

18. An audio high-speed reproduction method in an audio high-speed reproducing device which can reproduce audio data at high speed, the method comprising:
a reproduction speed switching step of gradually switching a reproduction speed of the audio data between equimultiple-speed reproduction and the high-speed reproduction;
a setting step of dividing each frame which constitutes the audio data and setting an object portion to be processed for each of a divided first-half block and a second-half block according to the reproduction speed switched in the reproduction speed switching step; and
a high-speed reproduction frame generating step of generating a high-speed reproduction frame in such a manner that the object portion to be processed of the first-half block is attenuated so that its attenuation rate gradually becomes high and the object portion to be processed of the second-half block is attenuated so that its attenuation rate gradually becomes low, and the attenuated object portion of the first-half block is superimposed onto the attenuated object portion of the second-half block.

19. A program product comprising an audio high-speed reproduction program, wherein
the audio high-speed reproduction program comprises a program step of executing a function of each means in the audio high-speed reproducing device according to claim 1 on a computer.

20. A program product comprising an audio high-speed reproduction program, wherein
the audio high-speed reproduction program comprises a program step of executing a function of each means in the audio high-speed reproducing device according to claim 10 on a computer.
